(19) United States
(12) Patent Application Publication
(10) Pub. No.: US 2002/0107768 A1
(43) Pub. Date: Aug. 8, 2002

(54) Transaction closing method, computer program, and system

(76) Inventors: Bradley S. Davis, Overland Park, KS (US); Robert E. Marsh, Kansas City, MO (US)

Correspondence Address: THOMAS B. LUEBBERING, HOVEY, WILLIAMS, TIMMONS & COLLINS, Suite 400, 2405 Grand Boulevard, Kansas City, MO, 64108, US

(21) Appl. No.: 09/778,542

(22) Filed: Feb. 7, 2001

(51) Int. Cl. G06F 17/60

(52) U.S. Cl. 705/35

(57) ABSTRACT

A method, computer program, and system for coordinating closing of one or more documents in a transaction via a communications network (16) such as the Internet so that the parties to the transaction do not have to carefully re-read finalized documents before closing. The method of the present invention is implemented with a host computer (12) that serves as a repository for all documents and other information created and exchanged by multiple parties to a transaction. The host computer (12) may be accessed by authorized parties via computers (14) networked with the host computer (12) via a communications network (16) such as the Internet.

### BACKGROUND OF THE INVENTION

1. Field of the Invention

The present invention relates to document management systems. More particularly, the invention relates to a method, computer program, and system for coordinating the closing of transactions via a communications network such as the Internet.

2. Description of the Prior Art

Parties to complex business and legal transactions often create and exchange numerous documents and then create and exchange revisions and drafts of the documents. Timely access to all of the documents, accurate determination of which documents are the most current, and the ability to provide comments relating to certain documents are all critical elements in a typical negotiation process. However, by the end of a complex transaction in which multiple drafts of multiple documents have been created and exchanged among many different parties, correct identification of the sequence of the documents, the source of the documents, and even the identification of the “final” versions of the documents is difficult and sometimes impossible. Although each party in a negotiation process may have its own document management system, such document management systems are only useful for coordinating and tracking internally-created documents for the particular party and are of no use in coordinating, tracking, and controlling the exchange of documents created and modified by other parties not subject to the document management system.

Another problem with conventional document management methods is that parties will often modify earlier created documents and then send them to the other parties without identifying the changes. The receiving parties must therefore compare the modified documents to the original documents word-for-word to identify the changes. Frequently, the modifications and changes are missed, causing a party to inadvertently finalize a transaction under a mistake of law or fact.

These document management problems have been further complicated by the increasing popularity of e-mail and the exchange of electronic draft documents. Parties who exchange electronic drafts of documents via e-mail often are unable to determine which version of a particular document is the “final” version, who has received a document, or even who authored a particular document.

Such difficulties in coordinating, tracking, and controlling the exchange of documents among multiple parties to a transaction increases the cost and complexity of the transaction and often leads to errors. Moreover, conventional document management methods produce large quantities of paper that is often merely discarded because the parties cannot determine the author, origin, or version of the documents.

Some of the above-described problems have been addressed in copending patent application entitled Method of Document Exchange, filed Jan. 4, 2000, and identified by application Ser. No. 09/477,199, hereby incorporated into the present application by reference. However, this application does not address problems relating to closing of documents. Specifically, when it is time to close one or more documents in a transaction, all parties to the transaction must ensure that they are signing the final version of the documents and that no further changes have been made to the documents. This necessitates that all parties to the transaction carefully re-read all documents before closing even if no known changes were made to the documents. Those skilled in the art will appreciate that the final review of documents before closing is a very time-consuming and tedious process.

### SUMMARY OF THE INVENTION

The present invention solves the above-described problems and provides a distinct advance in the art of document management methods and systems. More particularly, the present invention provides a method, computer program, and system for coordinating closing of one or more documents in a transaction via a communications network such as the Internet so that the parties to the transaction do not have to carefully re-read finalized documents before closing.

The method of the present invention is preferably implemented with a host computer that serves as a repository for all documents and other information created and exchanged by multiple parties to a transaction. The host computer may be accessed by authorized parties via computers networked with the host computer via a communications network such as the Internet.

Authorized parties to a transaction may use the host computer for coordinating, tracking, and controlling the electronic exchange of documents as described in detail in the pending application referenced above. Once a document has been created and has been stored on the host computer, a first one of the authorized parties may access the host computer and indicate a desire to close the document. The host computer then sends a notice of the desired closing to all of the other authorized parties.

The host computer then formats the indicated document to a viewable format such as a PDF file and then attaches a tag to the document. The tag preferably consists of a check sum, encrypted key, or other indicator of the exact contents of the document as well as a password or code corresponding to the party who indicated a desire to close the document. Other authorized parties may then access the host computer and request to read the PDF version of the document that the first authorized party indicated a desire to close. When one of the other authorized parties requests to view the PDF document, the host computer first verifies that the document has not been modified since the first authorized party attempted to close the document by evaluating the tag. The host computer then displays the document only if the tag indicates no changes have been made to the document.

Any of the other parties may then either accept or reject the closing of the document. If a second party accepts the requested closing, a second tag corresponding to the second party is attached to the PDF document. This process continues until all necessary parties have indicated that they accept the closing of the document. If all necessary parties approve the closing of the document, the host computer blocks further access to the document and stores the viewable document along with all of the tags to ensure that the document can no longer be modified by any of the parties. The closed document may then be printed at a later date for formal closing procedures.

However, if any of the necessary parties rejects the requested closing of the document, the host computer deletes the PDF document and all attached tags and notifies all authorized parties that the closing has been aborted. Then, any of the parties may re-initiate a closing at a later date once the document has been further modified.

The present invention provides numerous advantages not offered by prior art document management systems and methods of document exchange. For example, the present invention coordinates the closing of a document and ensures that a document that has been agreed upon cannot be modified prior to closing. Therefore, the parties do not have to carefully re-read every word of a document prior to closing.

These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is a schematic diagram of computer hardware and communications equipment that may be used to implement a preferred embodiment of the present invention.

FIG. 2 is a flow diagram depicting certain steps performed in a preferred implementation of the present invention.

FIG. 3 is a representation of a document that is part of a transaction.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

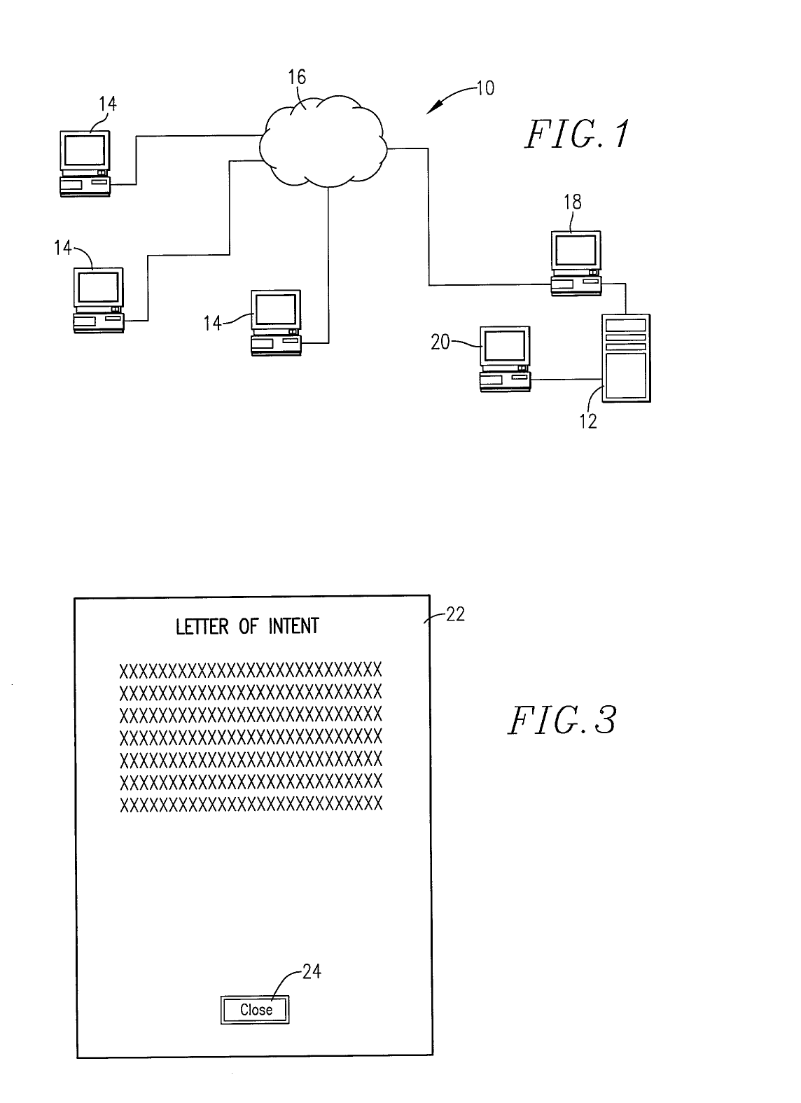

The present invention can be implemented in hardware, software, firmware, or a combination thereof. In a preferred embodiment, however, the invention is implemented with a computer program that operates a website that is hosted by and can be accessed with computer equipment broadly referred to by the numeral 10 in FIG. 1. The computer equipment 10 includes a host computer 12 and a plurality of computing devices 14 that may access the host computer 12 via a communications network 16. The computer program and equipment illustrated and described herein are merely examples of a program and equipment that may be used to implement a preferred embodiment of the present invention and may be replaced with other software and computer equipment without departing from the scope of the present invention.

In more detail, the host computer 12 serves as a repository for all documents and other information created and exchanged by multiple parties to a transaction. The host computer may be any computing device such as a network computer running Windows NT, Novell Net Ware, Unix, or other network operating system. The host computer is preferably connected to another computing device 18 that serves as a firewall to prevent tampering with information stored on or accessible by the host computer and may also be connected with other computing devices such as a computer 20 by a local area network or other network. The computer 20 may, for example, be used by an administrator of the host computer 12. The host computer preferably includes conventional web hosting operating software and includes an Internet connection such as a modem, DSL converter, or ISDN converter. The host computer is also assigned a domain name such as “recordscenter.com” so that it can be accessed via the Internet in a conventional manner.

The user computers 14 can be operated by the various parties to a transaction and may be any type of conventional computing devices including personal computers such as the ones sold by Dell, Compaq, Gateway, or other computer manufacturers. The user computers are networked to the host computer 10 via the communications network 16. The communications network 16 is preferably the Internet but may also be a local area network, a wide area network, or any other conventional network. Each user computer preferably includes a conventional Internet connection such as a modem, DSL converter, or ISDN converter and a web browser that permits it to access the Internet via the communications network.

The computer program of the present invention is stored in or on computer-readable medium residing on or accessible by the host computer 12 for instructing the host computer 12 to operate the website of the present invention as described herein. The computer program preferably comprises an ordered listing of executable instructions for implementing logical functions in the host computer 12 and computing devices 14 coupled with the host computer 12. The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

To implement the method of the present invention, the host computer 12 must first be configured to exchange documents and information with the user computers 14 via the communications network 16. In preferred forms, the host computer 12 is set up as an Internet web hosting server computer so that it may be accessed by the user computers 14 via the Internet.

The host computer 12 must then be configured to handle documents and other information relating to a particular transaction. To this end, a system administrator operating the host computer 12 first selects a transaction name or code to identify a particular transaction. The system administrator then identifies all authorized parties for the transaction and assigns each of the authorized parties an identification code and password that must be used to gain access to the documents and other records relating to the transaction. The authorized parties may include any persons or entities such as parties to a business transaction and their lawyers.

Once a transaction has been identified and authorized parties for the transaction have been designated, the system administrator, in conjunction with the authorized parties, identifies categories of documents that the parties anticipate will be created and exchanged during the course of the transaction. For example, in a business purchase transaction, the system administrator and the authorized parties may identify document categories including a stock purchase agreement, an employment agreement, a promissory note, and an officer's certificate. The system administrator creates a separate category for each of the possible types of documents and then sets up the host computer 12 to handle documents within each of these categories.

To facilitate use of the present invention, the host computer 12 is programmed to include a user interface that identifies each transaction, the document categories for the transaction, all the documents in each category, and all tracking information relating to the submission and downloading of the documents. The user interface permits the authorized parties to quickly and easily submit new and revised documents to the host computer 12, to download the documents from the host computer 12, and to determine the author, origin, and version and status of all the documents as discussed below.

Once the host computer 12 has been set up, the authorized parties may begin creating and exchanging documents relating to a particular transaction. The steps performed during such a document exchange are described in detail in the application entitled Method of Document Exchanged referenced above.

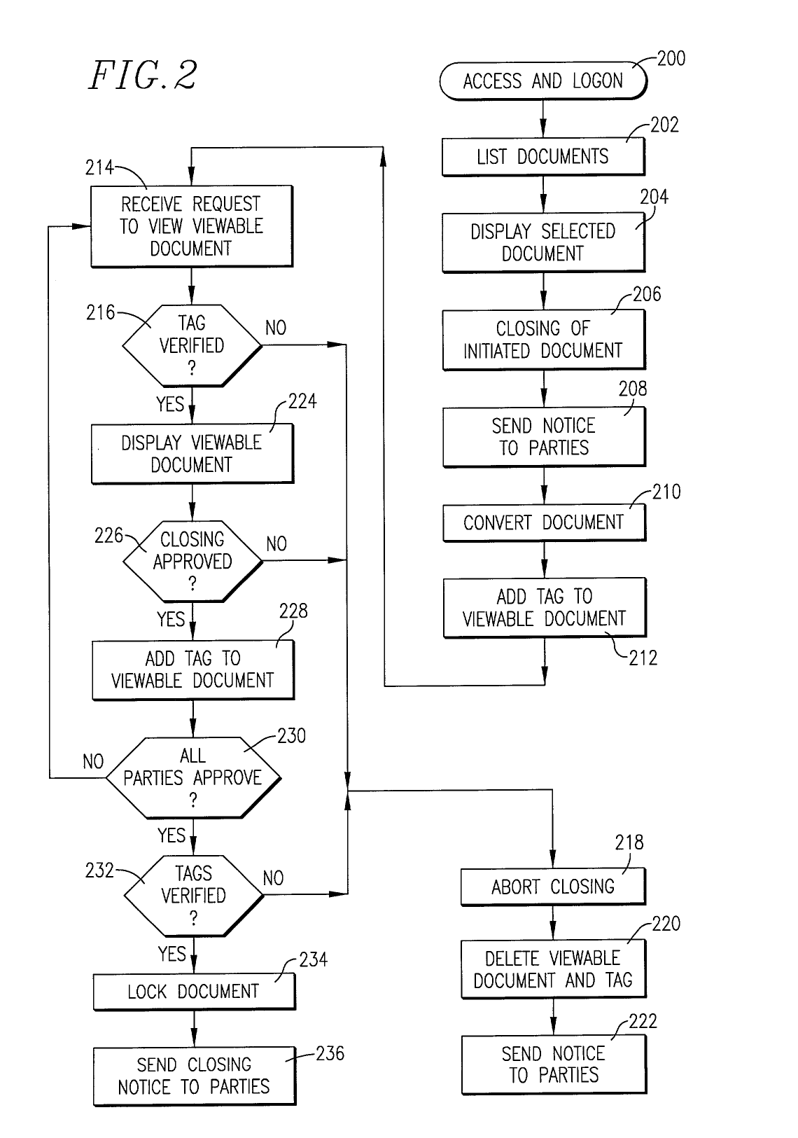

The present invention coordinates the closing of documents after they have been created and exchanged as described in the pending application referenced above. The flow chart of FIG. 2 shows the functionality and operation of a preferred implementation of the present invention in more detail. In this regard, some of the blocks of the flow chart may represent a module segment or portion of code of the computer programs of the present invention which comprises one or more executable instructions for implementing the specified logical function or functions. In some alternative implementations, the functions noted in the various blocks may occur out of the order depicted in FIG. 2. For example, two blocks shown in succession in FIG. 2 may in fact be executed substantially concurrently, or the blocks may sometimes be executed in the reverse order depending upon the functionality involved.

One of the authorized parties (hereinafter “first party” or “first authorized party”) first accesses the host computer 12 via one of the user computers 14 and the communications network 16 in a conventional manner as depicted in step 200. The host computer 12 then prompts the first party to enter his or her ID and/or a password. The host computer 12 verifies that the party is in fact authorized to use the host computer 12 and then accesses the appropriate transaction records based on the entered ID and/or password.

The host computer 12 next locates and displays the transaction records that the first party is authorized to view as depicted in step 202. For example, the host computer 12 may display a list of documents that are included in a particular transaction.

The first party may then choose to have one of the documents displayed as depicted in step 204. For example, the first party may request that a letter of intent 22 depicted in FIG. 3 be displayed. The letter of intent 22, as well as all other documents for a transaction, are displayed along with or next to an icon or tab 24, which when actuated by a party, indicates the party's desire to initiate closing of the document.

Returning to FIG. 2, the first party may initiate closing by merely actuating the tab 24 as depicted in step 206. The host computer 12 then automatically sends a notification to all of the other authorized parties that a closing of a document has been requested as depicted in step 208. The notifications are preferably sent from the host computer 12 to the user computers 14 via e-mail, but may be sent in any other conventional manner as well.

Before, during or after sending the notifications, the host computer 12 converts the document which the first party attempted to close into a viewable format such as an Adobe PDF file as depicted in step 210. This permits all authorized parties to access the host computer 12 and view the document with a web browser without having to first access the word processing program in which the document was originally created.

After the document has been converted into a PDF format, the host computer 12 attaches a first tag to the document as depicted in step 212. The tag preferably consists of two components: (1) a check sum or encrypted key that is representative of the exact contents of the document, and (2) the password, ID, or some other number or code that is representative of the first party. The tag therefore indicates the exact contents of the document and which party requested closing of the document.

After the first party requests a closing of a document, any of the other parties (hereinafter “second party” or “second authorized party”) may access the host computer 12 via one of the user computers 14 and request to view the document as depicted in step 214. Before displaying the document, the host computer 12 verifies that the viewable document has not been changed since the first authorized party attempted to close the document by evaluating the first tag as depicted in step 216. If the tag indicates that the document has been changed in any way, the program proceeds to step 218 where the closing is aborted. The host computer 12 does so by deleting the viewable document and the tag as depicted in step 220 and then sending notice to all of the authorized parties that the closing has been aborted as depicted in step 222.

However, if the host computer 12 confirms that the viewable document has not been changed since the first party attempted to close the document, the program proceeds to step 224 where the document is displayed for the second party. The program then displays icons or tabs that allow the second party to either accept or reject the closing as depicted in step 226. If the second authorized party rejects the closing, the program proceeds to steps 218-222 where the closing is aborted as described above.

However, if the second authorized party accepts the closing, the program proceeds to step 228 where it adds a second tag to the viewable document. As with the first tag, the second tag preferably consists of two components: (1) a check sum or encrypted key that is representative of the exact contents of the document, and (2) the password, ID, or some other number or code that is representative of the second party.

After the first and second authorized parties have agreed to close the document, the program proceeds to step 230 where it determines if all necessary parties have approved the closing. If more parties must still approve the closing, the program loops back to step 214 to await a request from the other authorized parties. Steps 214-230 are then repeated until all authorized parties accept the closing or until one of the parties rejects the closing.

When and if all authorized parties accept the closing, the program proceeds to step 232 to once again verify that the document has not been changed since the first party indicated a desire to close the document or since the subsequent parties accepted the closing. If the document has been changed, the program proceeds to steps 218-222 to abort the closing as described above.

If, however, the document has not been changed, the program proceeds to step 234 where it locks the document to prevent any further access. This prevents the authorized parties or anyone else having access to the host computer 12 from modifying the document after it has been accepted for closing.

The host computer 12 then sends a notice to all of the parties that the document has been approved for closing as depicted in step 236. As with the other notices, the closing notice is preferably sent from the host computer 12 to the user computers 14 via the Internet 16. The authorized parties may then access the host computer 12 at a later date to print the final version of the document for closing.

From the foregoing description, it can be seen that the present invention coordinates the closing of documents in a transaction and ensures that documents cannot be modified prior to closing. Therefore, the parties to a transaction do not have to carefully re-read every word of a document prior to closing. The tags of the present invention also provide proof that the parties agreed to a closing of a document.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A computer program stored on a computer-readable memory device for enabling a repository computer to coordinate closing of a transaction by a plurality of authorized parties each operating a user computer, the computer program comprising:
a code segment operable to permit the authorized parties to access the repository computer via the user computers;
a code segment operable to display a list of documents corresponding to the transaction;
a code segment for permitting a first one of the authorized parties to attempt to close one of the documents;
a code segment for sending a notice of the desired closing to at least a second one of the parties;
code segment for formatting the document into a viewable document;
a code segment for attaching to the viewable document a first tag corresponding to the first authorized party;
a code segment for receiving a request from the second authorized party to view the viewable document;
a code segment for verifying that the viewable document has not been changed since the first authorized party attempted to close the document by evaluating the first tag;
a code segment for displaying the viewable document to the second authorized party if the document has not been changed;
a code segment for permitting the second party to accept or reject the closing of the document;
a code segment for adding a second tag to the viewable document if the second authorized party accepts the closing of the document; and
a code segment for indicating that the document has been approved for closing.

2. The computer program as set forth in claim 1, wherein the code segment for formatting the document formats the document into a PDF file.

3. The computer program as set forth in claim 1, wherein the user computers access the repository computer via a communications network.

4. The computer program as set forth in claim 3, the computer network comprising the Internet.

5. The computer program as set forth in claim 1, further including a code segment for notifying all of the authorized parties that the document has been approved for closing.

6. The computer program as set forth in claim 1, further including a code segment operable to delete the viewable document and the first tag if the second authorized party rejects the closing of the document.

7. The computer program as set forth in claim 6, further comprising a code segment for notifying all of the authorized parties that the closing of the document has been rejected.

8. The computer program as set forth in claim 1, wherein the first and second tags each include a check sum of the viewable document and a code corresponding to the first or second authorized party.

9. A method of coordinating closing of a transaction, the method comprising the steps of:
providing a repository computer for storing a plurality of documents related to the transaction;
permitting authorized parties to access the repository computer via user computers;
permitting a first one of the authorized parties to indicate a desire to close one of the documents;
sending a notice of the desired closing to at least a second one of the parties;
formatting the document to a viewable document;
attaching to the viewable document a first tag corresponding to the first authorized party;
receiving a request from the second authorized party;
verifying that the viewable document has not been changed since the first authorized party attempted to close the document by evaluating the first tag;
displaying the viewable document to the second authorized party if the document has not been changed;
permitting the second party to accept or reject the closing of the document;
adding a second tag to the viewable document if the second authorized party accepts the closing of the document; and
indicating that the document has been approved for closing.

10. The method as set forth in claim 9, wherein the code segment for formatting the document formats the document into a PDF file.

11. The method as set forth in claim 9, wherein the user computers access the repository computer via a communications network.

12. The method as set forth in claim 11, the computer network comprising the Internet.

13. The method as set forth in claim 9, further including a code segment for notifying all of the authorized parties that the document has been approved for closing.

14. The method as set forth in claim 9, further including a code segment operable to delete the viewable document and the first tab if the second authorized party rejects the closing of the document.

15. The method as set forth in claim 14, further comprising a code segment for notifying all of the authorized parties that the closing of the document has been rejected.

16. The method as set forth in claim 9, wherein the first and second tags each include a check sum of the viewable document and a code corresponding to the first or second authorized party.

17. A computer program stored on a computer-readable memory device for enabling a repository computer to coordinate closing of a transaction by a plurality of authorized parties each operating a user computer, the computer program comprising:
a code segment operable to permit the authorized parties to access the repository computer via the user computers;
a code segment operable to display a list of documents corresponding to the transaction; and
a code segment for preventing closing of one of the documents if the document has been modified after one of the authorized parties indicates a desire to close the document.

18. A method of coordinating closing of a transaction, the method comprising the steps of:
providing a repository computer for storing a plurality of documents related to the transaction;
permitting authorized parties to access the repository computer via user computers; and
preventing closing of one of the documents if the document has been modified after one of the authorized parties indicates a desire to close the document.
